(19) United States
(12) Patent Application Publication
(10) Pub. No.: US 2012/0070690 A1
(43) Pub. Date: Mar. 22, 2012

(54) Composition and Method for Producing ITO Powders or ITO Coatings

(76) Inventors: Carsten Bubel, Muenchen (DE); Michael Veith, St.-Ingbert (DE); Peter William de Oliveira, Saarbruecken (DE)

(21) Appl. No.: 13/321,187

(22) PCT Filed: May 18, 2010
(86) PCT No.: PCT/EP2010/003002

§ 371 Date: Nov. 18, 2011

(30) Foreign Application Priority Data
May 20, 2009 (DE) 10 2009 022 097.6

(51) Int. Cl. C01G 19/02; B05D 5/12; B32B 9/00; C07F 19/00

(52) U.S. Cl. 428/697; 556/28; 423/594.9; 427/126.3

(57) ABSTRACT

A composition for preparing ITO powders and ITO coatings includes at least one indium compound and at least one bimetal compound which includes indium and tin. A method of preparing ITO powders and ITO coatings includes a one-step temperature treatment in an inert atmosphere.

### FIELD OF THE INVENTION

The invention relates to a composition and a process for producing ITO powders or ITO coatings, in particular compositions which are based on single-source precursors.

### PRIOR ART

Despite the intensive research work in recent decades and the continually growing importance of ITO for industrial applications, important theoretical and technical problems have still not been solved. Thus, although optimization of the electrical properties of the material by means of complicated methods has progressed a long way, the precise conductivity mechanisms of this degenerated n-semiconductor continue to remain unclear, which applies particularly to the role and function of the introduced tin.

Furthermore, present-day techniques frequently lack reproducibility and homogeneity of the layers. In particular, the effectiveness of the dopant (tin) is unsatisfactory since large proportions of the tin introduced in excess do not contribute to the conductivity of the layer or even form scattering centers which impair the electrical properties of the material as a result of cluster formation (e.g. at grain boundaries).

The process of ITO application which is employed most widely at present is sputtering by means of which layers having the best optical and electrical quality can be produced. However, this requires costly and complicated vacuum apparatuses which for technical reasons restrict the size and shape of the substrates used (glass, polymer) and prevent a continuous coating process.

As an alternative to the sputtering process, the sol-gel process offers greater flexibility in respect of the substrate size and shape (dip coating, spin coating, spray techniques). In addition, the layer parameters can be set in a targeted manner by varying the solution composition. At the same time, it is also possible to produce the ITO in powder form which can be used as starting material for dispersion-based sols.

The composition of the coating solution for ITO sol-gel layers plays an important role. For this purpose, the alkoxides or halides of the metals indium and tin are usually dissolved in appropriate stochiometric proportions in a (usually alcoholic) solvent and provided with additives. These ensure, inter alia, uniform application of the layer to the substrate. The solubility of the indium and tin precursors is usually different due to the molecule, so that homogeneous mixing of the two components is problematical and may be able to be ensured only by addition of further additives (other solvent).

When the solution is applied to the substrate, the two metal components hydrolyze and condense with elimination of the organic or halide ligands. A xerogel is formed. Owing to the different tendency of the two components to hydrolyze, phase separation or an insufficiently homogeneous distribution of the tin in the indium-containing network can occur and can be only partly eliminated under diffusion control by means of intensive and long heat treatment processes.

Large proportions of organic material (solvent, alcohol residues, etc.) are always still present in the xerogel. These are removed (burnt out) in the subsequent heat treatment. A similar situation applies to the equivalent metal halides in the case of which the eliminated halide ligand is at least partly removed from the layer material during the heat treatment.

To achieve satisfactory electrical conductivity values, two heat treatment steps are necessary for producing ITO sol-gel layers:
crystallization of the xerogel in air, during which remaining organic or halogen-containing residues are also burnt out at high temperatures (usually about 500° C.) (calcination).
Reduction of the material to produce the necessary conductivity.

This two-stage process has some disadvantages. Thus, the foreign atoms introduced have to be removed by the calcination. Particularly when halide compounds are used, this represents a problem. These foreign atoms reduce the purity of the ITO coatings obtained. At the same time, the tin is oxidized to Sn(IV) under these conditions.

The second step occurs in a reducing atmosphere (H₂, CO) at elevated temperature (>300° C.). This produces oxygen vacancies in the oxide lattice. At the same time, the metal cations are reduced (In^{III}→In^{I}→In⁰;Sn^{IV}→Sn^{II}→Sn⁰).

The oxygen vacancies formed in this way and the previous incorporation of Sn⁴⁺ cations give the material its conductive properties and the reflective properties in the infrared spectral region.

When producing ITO layers (and powders) by the sol-gel process, some process-related problems have to be overcome.

These include, inter alia, the complete dissolution and mixing of the two metal precursors (alkoxides, halides) in the given solvent (e.g. isopropanol) in order to obtain a homogeneous composition.

In the actual step of the sol-gel process, phase separation or unsatisfactory mixing of the (hydrolyzed) starting materials can occur because of different hydrolysis and condensation tendencies.

The subsequent heat treatments have to be carried out in two stages (crystallization and reduction).

In the reduction step, it also has to be ensured that the material is not reduced too much and for too long and the metals are therefore present in elemental form and blacken the layer (“over-reduction”).

The above-described processes for producing ITO layers all work according to the standard principle for ITO. To obtain an optically transparent and electrically conductive ITO layer, a crystalline indium oxide lattice has to be initially provided and free electrons for charge transport are made available in this by incorporation of Sn⁴⁺ ions and a subsequent reduction step (formation of oxygen vacancies). This reduction step is carried out by heating in a reducing atmosphere (N₂/H₂).

Heat treatments under an inert gas atmosphere have now also been described in the literature. However, these use exclusively Sn(IV) starting materials, or the Sn(II) starting materials used are converted beforehand into Sn(IV) by heating under an oxidizing atmosphere (air). The predominant effect which explains the increased conductivity is thus merely the formation of oxygen vacancies as a result of the low oxygen partial pressure during the heat treatment under inert gas. A change in the valance of the tin can no longer occur since the tin is already present in its most stable form Sn^{IV} and reducing conditions do not prevail.

To be able to coat temperature-sensitive substrates, too, another approach starts out from ITO powders which are embedded in a polymer matrix. This allows curing at moderate temperatures. Such powders are usually produced by means of sol-gel or precipitation techniques.

### OBJECT OF THE INVENTION

It is an object of the invention to provide a composition which overcomes the abovementioned problems of the prior art, in particular the unsatisfactory mixing and the phase separation of the components in the composition or in the xerogel. In addition, it is an object of the invention to provide a process for producing ITO coatings and ITO powders.

### ACHIEVEMENT OF THE OBJECT

This object is achieved by the inventions having the features of the independent claims. Advantageous embodiments of the inventions are characterized in the dependent claims. The wording of all claims is hereby incorporated by reference into the present description. The invention also encompasses all meaningful combinations and in particular all combinations mentioned of independent and/or dependent claims.

The object is achieved by a composition for producing ITO powders or ITO coatings, which contains

a) at least one indium compound; and

b) at least one bimetallic compound containing indium and tin.

Such a composition has advantageous properties from a number of points of view. Thus, the composition avoids problems of mixing of the indium compound and the tin compound. The tin required for doping can be controlled via the proportion of the bimetallic compound. The use of a bimetallic compound also ensures that the tin or the tin ions are incorporated directly into the indium oxide lattice. This avoids the formation of clusters of tin.

In a preferred embodiment, the tin is present in the oxidation state +2 in the bimetallic compound. In conventional process techniques, the tin is either used directly in its most stable valence Sn⁴⁺ (e.g. SnCl₄) or a transformation of the metastable phase Sn²⁺ into Sn⁴⁺ occurs during crystallization in the air furnace. In both cases, the tin is present in tetravalent form (SnO₂) in the oxide lattice. To ensure charge carrier neutrality (substitutional incorporation of Sn⁴⁺ in In³⁺ positions), additional oxygen is incorporated in interstitial lattice sites, which is partly removed again in the subsequent reduction step. During this reduction step, the Sn⁴⁺ is also reduced to Sn²⁺ or even to Sn⁰.

Divalent tin, on the other hand, disproportionates at temperatures above 300° C. according to the following equation:

2SnO<-->Sn⁰+SnO²

This reaction takes place under an inert atmosphere. A similar distribution of the valence of the tin ions in the indium oxide to that in known ITO production processes is obtained in this way, but only one heat treatment step is necessary and the use of explosive or toxic gases (H₂, CO) is avoided. The metallic Sn⁰ formed is not segregated as an additional phase but instead is homogeneously distributed without cluster formation in the oxide material. Furthermore, the incorporation of interstitial oxygen in order to achieve charge carrier neutrality and its subsequent removal is dispensed with, or is at least substantially reduced, by means of this technique.

However, the composition of the invention can likewise be treated in the above-described two-stage process (calcination, reduction). This process, too, gives high quality ITO coatings or ITO powders.

Compounds of the formula InR¹₃, where R¹ can be identical or different, are used as indium compound. R¹ is preferably selected from the group consisting of straight-chain or branched alkyl, alkoxy and carboxyl radicals, halides, amines, alkylated amines. The radicals can also be bound to one another, which leads to formation of cyclic compounds, e.g. by means of chelating ligands (ethanediol, propanediol or ethers of these compounds) or ligands which can intramolecularly stabilize the metal center, e.g. alkyl radicals having hydroxyl groups or ether groups.

The bimetallic compound is characterized in that the two metal centers are present in one molecule. As a result, the two metal ions are present in a fixed ratio. The bonds between the metal centers can be covalent, for example by means of bridging ligands. However, they can also be ionic or coordinate, i.e., for example, by coordination of an electron donor such as oxygen to a metal center.

In an advantageous embodiment, the bimetallic compound is a coordination compound of a tin compound with an indium compound. This means that the bimetallic compound is formed by coordination of a tin compound to an indium compound. Indium(III) compounds are, like most trivalent compounds of group 13, electron deficient compounds. The electron gap on the metal can be closed by formation of multicenter bonds and also by formation of adducts with Lewis bases (electron donors). The choice of radicals on the indium makes it possible for the stability of such adducts to be controlled precisely by choice of the size and the electron properties.

Tin compounds, in particular Sn(II) compounds, can also form such coordinate bonds.

To obtain such a coordination compound composed of a tin compound and an indium compound, each of the compounds preferably has Lewis-basic groups (X) which form a coordinate bond to the other metal center:

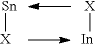

Here, the Lewis-basic groups X can also be joined via a plurality of bonds to the metal center. Preference is given to direct bonding of the Lewis-basic groups to the metal center. X can be O, N or S, with O being preferred. Examples of X are alkoxy groups having from 1 to 8 carbon atoms, for example methoxy, ethoxy, propoxy, isopropoxy, butoxy, tert-butoxy groups.

The coordination compound can also be present in equilibrium with the tin compound and the indium compound. However, the equilibrium is shifted to the side of the complex by selection of the ligands and the indium compound which is usually present in great excess.

The molecular weight of the bimetallic compound is preferably below 2000 g/mol, particularly preferably below 1000 g/mol, but above 350 g/mol, preferably above 500 g/mol.

The bimetallic compound advantageously has a ratio of In to Sn atoms of 1:1. The complex advantageously contains precisely one In atom and one Sn atom.

Despite the equilibrium, the coordination compound can also be characterized satisfactorily by experimental measurements such as NMR measurements.

In a further embodiment, the indium compounds are compounds of the formula I

R²₂InR³ (I)

where the radicals R² are selected from the group consisting of straight-chain or branched alkyls, preferably having from 1 to 8 carbon atoms, particularly preferably methyl, ethyl, propyl, butyl, isopropyl, alkenyl groups having from 1 to 8 carbon atoms and aryl groups such as phenyl. R³ is a ligand which is bound to the indium via a heteroatom such as O, N or S, e.g. alkoxy groups, alkylamines, phenoxy or carboxyl groups. Preference is given to alkoxy groups which may also contain further heteroatoms. Particular preference is given to C₁-C₁₂-alkoxy groups such as methoxy, ethoxy, propoxy, isopropoxy, n-butoxy, tert-butoxy, pentoxy, neopentoxy. The indium compound is preferably a dialkylindium compound, in particular with a further radical having at least one Lewis-basic group such as an alkoxy group.

As tin compounds, it is advantageous to use tin compounds which have radicals having Lewis-basic groups. Preference is given to tin halides, tin alkoxides. Particular preference is given to compounds having tin in the oxidation state +2. These are, in particular, compounds of the formula SnR³₂, where R³ is as defined above, preferably C₁-C₁₂-alkoxy groups such as methoxy, ethoxy, propoxy, isopropoxy, n-butoxy, tert-butoxy, pentoxy, neopentoxy.

In an advantageous embodiment, the bimetallic compound is obtained by reaction of an indium compound with an appropriate tin compound.

In a particularly preferred embodiment, the indium compound for producing the bimetallic compound corresponds to the indium compound of the composition of the invention. This allows particularly simple production of a precursor composition for a composition for producing ITO coatings and ITO powder. For this purpose, a proportion of tin compound selected in accordance with the required doping is added to the indium compound and the bimetallic compound is formed by reaction with an appropriate part of the indium compound. The mixture obtained can be purified and used as a homogeneous mixture. The coordination compound is retained here. A readily handleable homogeneous precursor composition which is to be processed further with a tin content in the final ITO coating which can be set precisely can be obtained in this way. A composition according to the invention for producing ITO coatings or ITO powders can then be obtained from this precursor composition either directly or after addition of further compounds. If nothing more is added, the precursor composition corresponds to a composition according to the invention.

In an advantageous embodiment, the indium compound is a compound of the formula II

R⁴₂InOR⁵ (II)

and the bimetallic compound is a compound of the formula III

R⁴₂In(OR⁵)₃Sn (III)

where R⁴ and R⁵ are identical or different and are each a linear or branched alkyl radical having from 1 to 8 carbon atoms. R⁴ is preferably methyl, ethyl, propyl or butyl and R⁵ is preferably propyl, n-butyl or tert-butyl.

Depending on the desired tin doping, the composition or the precursor composition has a proportion of from 1 to 50 at % of tin ([Sn]/([Sn]+[In])), preferably a proportion in the range from 5 to 30 at % of tin, particularly preferably in the range from 5 to 20 at % of tin.

The indium compound can also be an indium compound of the formula I which is used together with the bimetallic compound of the formula III.

In formula III, Sn is preferably present in the oxidation state +2. In is preferably present in the oxidation state +3.

In an advantageous embodiment, the composition additionally contains one or more organic compounds having Lewis-basic groups. These groups serve, firstly, to stabilize the precursor composition during further processing and also to improve the properties of the powders and coatings obtained. Preference is given to Lewis-basic groups containing oxygen. The proportion of the compounds can be selected so that a composition according to the invention has a concentration of from 0.1 to 0.6 M of the precursor composition based on the total concentration of indium compound and bimetallic compound. Preference is given to a concentration of from 0.15 to 0.45 M.

The proportion of such a compound in the precursor composition can be from 10 to 50% by volume, preferably 20-40% by volume.

Such Lewis-basic compounds can, for example, be selected from among:

a. C₁₋₆-alcohols such as methanol, ethanol; propanol, isopropanol, n-butanol, isobutanol,

b. monocarboxylic and polycarboxylic acids such as formic acid, acetic acid, propionic acid, butyric acid, pentanoic acid, hexanoic acid, acrylic acid, methacrylic acid, crotonic acid, citric acid, adipic acid, succinic acid, glutaric acid, oxalic acid, maleic acid, fumaric acid, itaconic acid, stearic acid and in particular 3,6,9-trioxadecanoic acid and also the corresponding anhydrides,

c. ketones, diketones or hydroxyketones such as acetylacetone, 2,4-hexanedione, 3,5-heptanedione, acetoacetic acid, C₁-C₄-alkyl acetoacetates such as ethyl acetoacetate, diacetyl and acetonylacetone, β-hydroxyketones, diacetone alcohol,

d. amino acids, in particular β-alanine, but also glycine, valine, aminocaproic acid, leucine and isoleucine,

e. polyethylene oxide derivatives, in particular Tween 80 (sorbitan monooleate-polyoxyalkylene), but also Emulsogen® (hexaglycol monostearate), Emulsogen® OG (oleic acid derivative) and Brij® 30 (polyoxyethylene lauryl ether),

f. acid amides, in particular caprolactam, and

g. amines such as methylamine, dimethylamine, trimethylamine, aniline, N-methylaniline, diphenylamine, triphenylamine, toluidine, ethylenediamine, diethylenetriamine.

Preference is given to compounds which in addition to oxygen have only carbon and hydrogen, in particular C₁₋₆-alcohols, carbonyl compounds, β-hydroxyketones, β-diketones, (poly)ethers, particularly preferably β-hydroxyketones such as diacetone alcohol. This reduces the amount of foreign atoms introduced.

It is also possible to use mixtures of the compounds, e.g. mixtures of alcohols and β-hydroxyketones.

In addition to these compounds, the composition can additionally contain further solvents and/or other compounds. For example, further solvents such as diethyl ether, tetrahydrofuran and also inert solvents such as toluene, benzene, pentane are also conceivable.

The invention also provides a bimetallic precursor, in particular for producing ITO coatings and ITO powders, which is a coordination compound of an indium compound and a tin compound and contains tin in the oxidation state +2.

Such a bimetallic precursor can be obtained, in particular, by reaction of an indium compound having at least one Lewis-basic group, preferably an indium compound of the formula I, particularly preferably an indium compound of the formula II, and a tin compound of the formula Sn(OR)₂, where R is defined like R⁵ in formula III.

The bimetallic precursor is preferably defined like the bimetallic compound of the composition of the invention. The bimetallic precursor is particularly preferably a compound of the formula III

R⁴₂In(OR⁵)₃Sn (III)

where R⁴ and R⁵ are as defined above.

The invention also provides a process for producing ITO coatings. In the following, individual process steps are described in more detail. The steps do not necessarily have to be carried out in the order indicated, and the process to be described can also have further steps which are not mentioned.

The process comprises at least the following steps:

a) production of a composition composed of at least one indium compound and at least one bimetallic compound containing indium and tin;

b) application of the composition to a substrate;

c) heat treatment at above 300° C.

As composition, preference is given to using a composition according to the invention which has been described above.

Application can be carried out using processes known to those skilled in the art for the coating of surfaces. Preference is given to spin coating, dip coating or roller coating or spray processes. Depending on the desired method of application, the composition can contain different concentrations of the precursor composition. Preference is given to a concentration of from 0.15 to 0.6 M based on the total concentration of indium compound and bimetallic compound.

In a further step, the coating is subjected to a heat treatment at above 300° C.

The heat treatment can, in an embodiment of the invention, be carried out by the known process of crystallization (calcination) and reduction. For this purpose, the coating is firstly treated in air at above 300° C., usually about 500° C., for a number of hours, usually about 12 hours. This leads, as described above, to oxidation to Sn⁴⁺ compounds.

In a second step of the heat treatment, a heat treatment is carried out in a reducing atmosphere, likewise at above 300° C., usually for a significantly shorter time, about 30 minutes. This is necessary to prevent over-reduction of the coating. As atmosphere, it is possible to use H₂ or CO, with preference being given to an N₂/H₂ atmosphere having an H₂ content of 5-15%.

In a particularly preferred embodiment of the invention, the heat treatment is carried out in one step under an inert atmosphere. As described above, disproportionation of Sn²⁺ and thus formation of charge carriers in the ITO coating occurs here. As inert atmosphere, it is possible to use N₂, CO₂ or noble gases, preferably N₂. The temperature should be above 300° C., preferably in the range from 300 to 800° C., particularly preferably from 450 to 600° C. Relatively sensitive substrates can also be used as a result of the inert atmosphere. The treatment can be for from 2 to 48 hours, preferably from 5 to 24 hours, particularly preferably from 8 to 15 hours.

In an advantageous embodiment of the invention, the composition additionally contains one or more organic compounds having Lewis-basic groups, as described above, with preference being given to C₁₋₆-alcohols, carbonyl compounds, β-hydroxyketones, β-diketones, (poly)ethers.

Furthermore, the invention provides a process for producing an ITO powder. This is analogous to the above-described process for producing an ITO coating, but instead of step b), the composition is dried at below 100° C. and then subjected to a comminution treatment. The process therefore comprises the following steps:

a) production of a composition composed of at least one indium compound and at least one bimetallic compound containing indium and tin;

b) heat treatment of the composition at below 100° C. and then a comminution treatment;

c) heat treatment at above 300° C.

Preference is given to using a composition according to the invention. To produce an ITO powder, any further organic compounds present, e.g. alcohols, are firstly removed by heat treatment at below 100° C. The composition obtained is subjected to a comminution treatment. This comprises techniques known to those skilled in the art, for example mortars, hard mortars, mills. The powder which has been comminuted in this way is subjected to a heat treatment at above 300° C. Here, single-stage or two-stage processes can be used as described above.

The powder obtained can then be subjected to further comminution or dispersing treatments. The particles can also be surface-modified by addition of surface modification. Techniques for this purpose are known to those skilled in the art.

The powders obtained have a crystallite size below 200 nm, preferably below 50 nm, particularly preferably in the range from 10 to 15 nm.

The invention further provides articles containing or having a coating which has been obtained by the process of the invention.

These are all uses known to those skilled in the art for ITO coatings and ITO powders, in particular conductive and/or transparent coatings in microelectronic and/or optoelectronic applications. The coatings are, for example, particularly suitable as NIR absorbers on surfaces.

Applications which may be mentioned by way of example are: touch screens, display technology, electrodes.

Further details and features may be derived from the following description of preferred examples in combination with the dependent claims. Here, the respective features can be realized by themselves or in a combination of a plurality thereof with one another. The possible ways of achieving the object of the invention are not restricted to the examples. Thus, for example, ranges always encompass all intermediate values which are not mentioned and all conceivable subranges.

The invention will now be illustrated with the aid of some examples. The examples are schematically shown in the figures. In detail:

Table 4 lists various processes and compositions which were produced (Daa denotes diacetone alcohol).

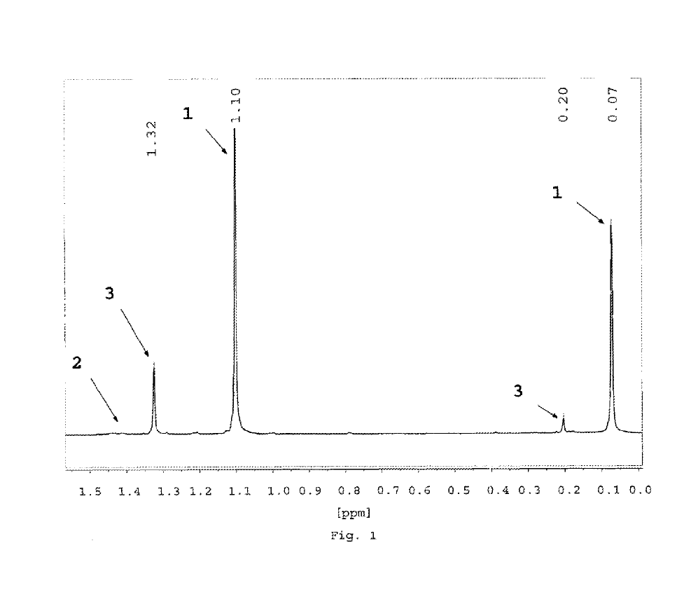

FIG. 1 shows a ¹H-NMR spectrum of a precursor composition according to the invention containing 10 at % of Sn;

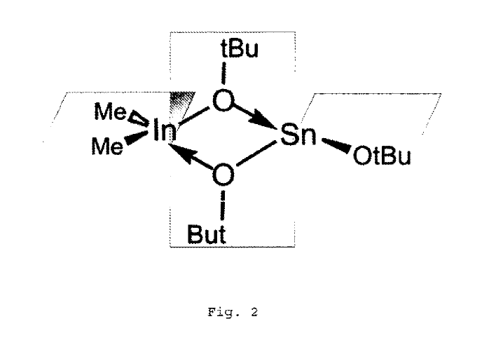

FIG. 2 shows the structural formula of Me₂In(OtBu)₃Sn;

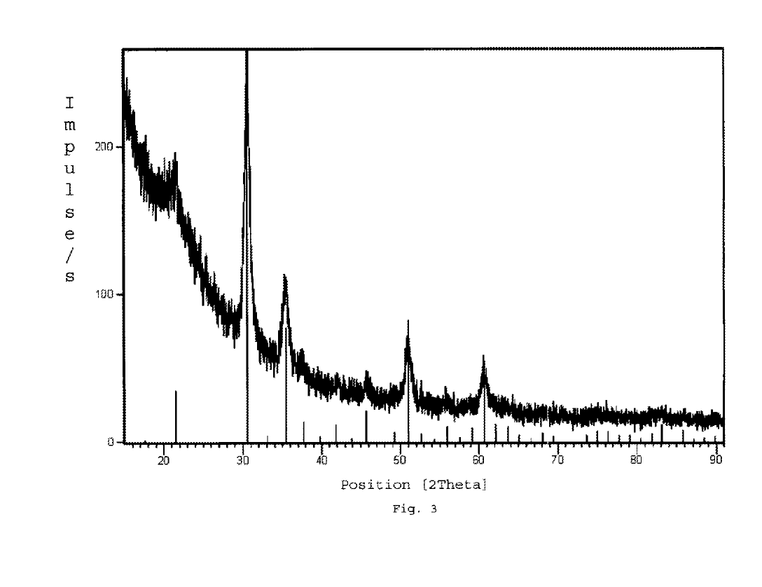

FIG. 3 shows an X-ray diffraction pattern (XRD) of a coating containing 10 at % of Sn from 0.4 M solution with heat treatment under an inert atmosphere;

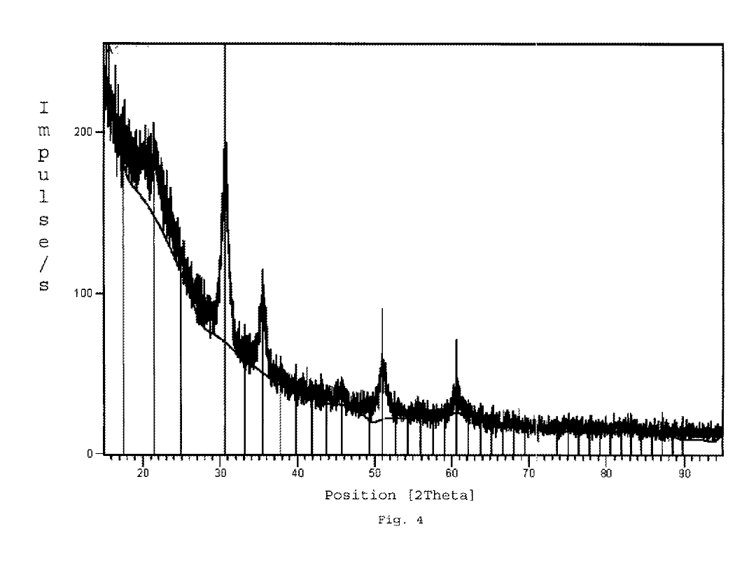

FIG. 4 shows an X-ray diffraction pattern (XRD) of a coating containing 10 at % of Sn from 0.4 M solution with heat treatment in two stages;

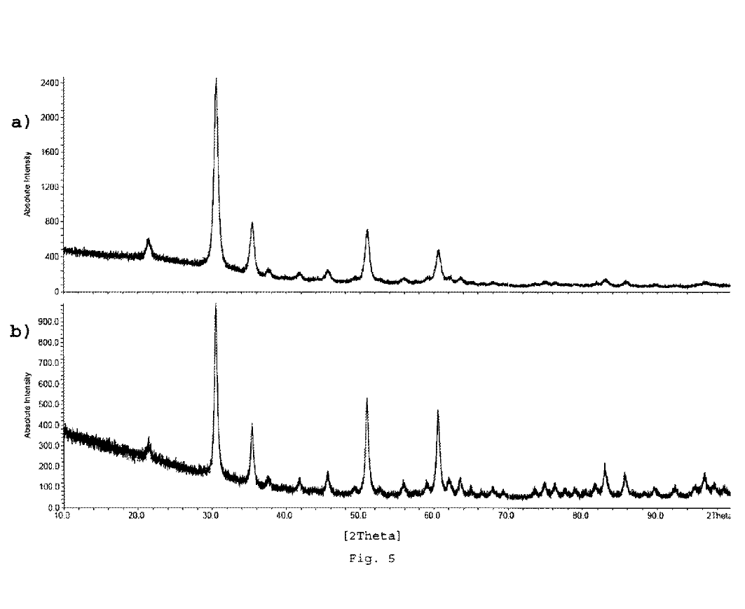

FIG. 5 shows powder diffraction patterns of powders containing 10 at % of Sn from 0.4 M solution heat treated under an inert atmosphere (a) and with two-stage heat treatment (b);

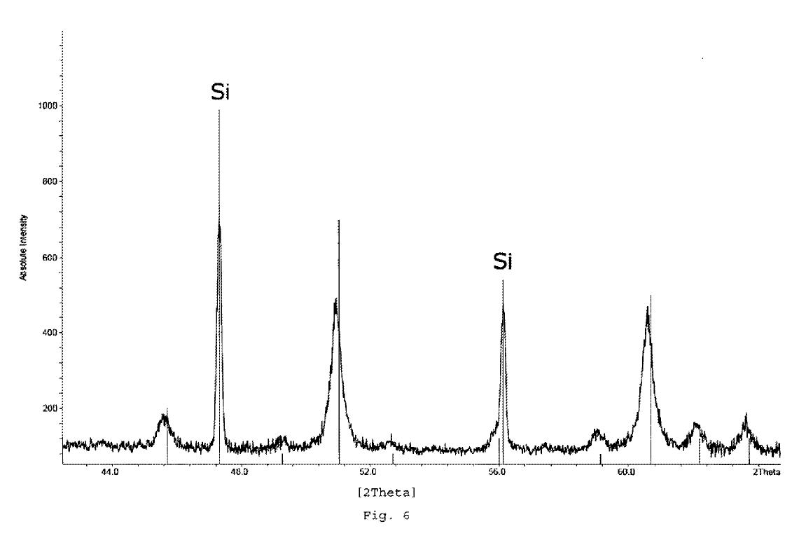

FIG. 6 shows an analysis of the powder diffraction pattern of a powder containing 10 at % of Sn from 0.4 M solution heat treated under an inert atmosphere; calibrated against silicon;

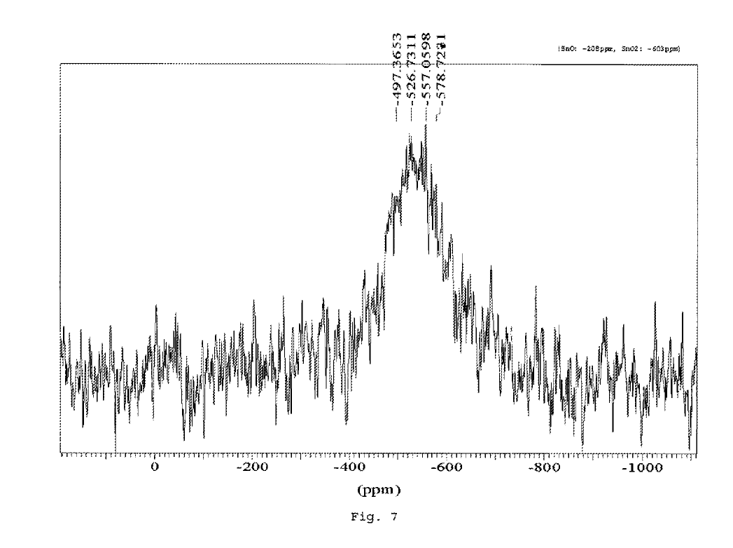

FIG. 7 shows a solid-state NMR measurement of a sample which has not been heat treated;

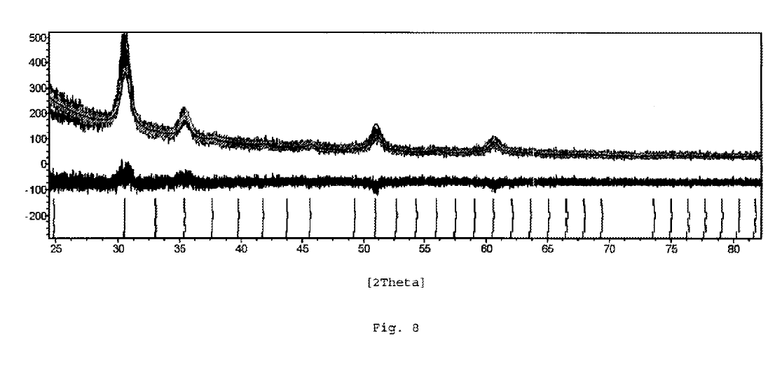

FIG. 8 shows a measurement of the crystallite sizes by the Scherrer method;

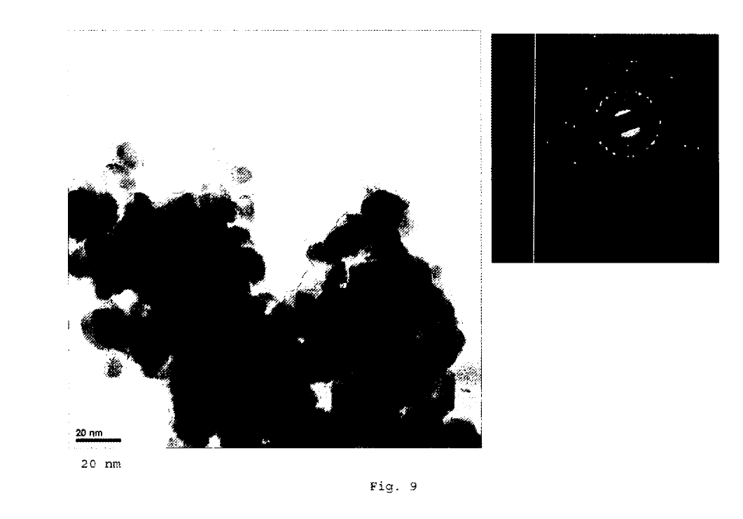

FIG. 9 shows a transmission electron micrograph of a powder produced under an inert atmosphere;

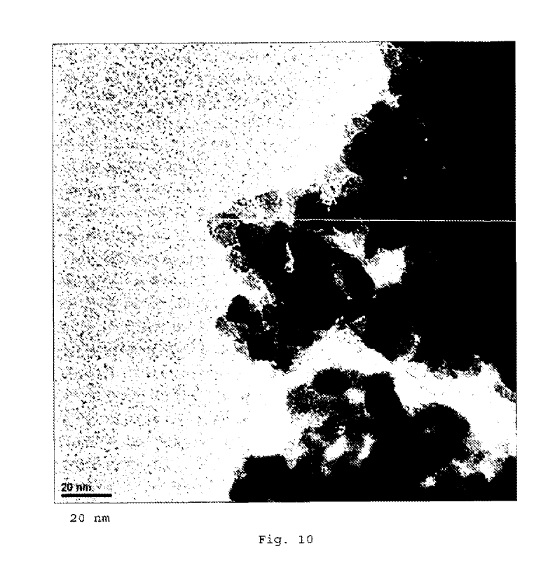

FIG. 10 shows a transmission electron micrograph of a powder produced in a two-stage process;

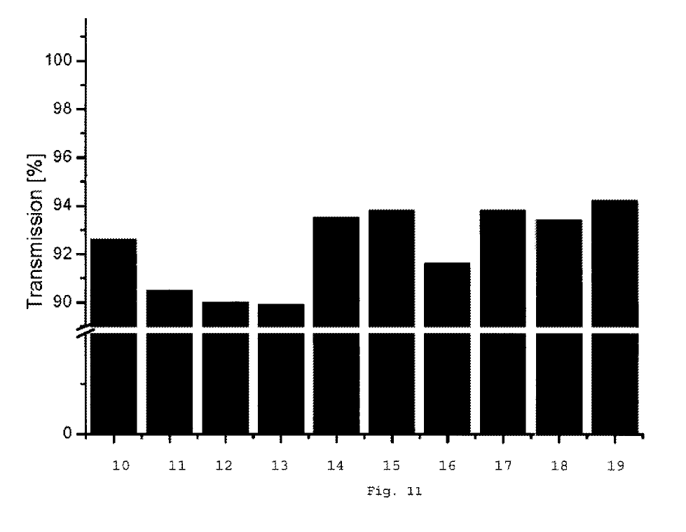

FIG. 11 shows the transmission of various coatings on borosilicate glass;

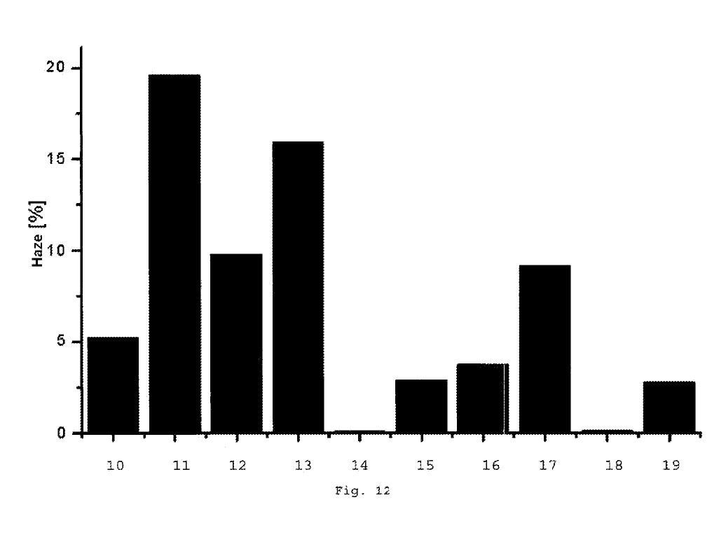

FIG. 12 shows haze of various coatings on borosilicate glass;

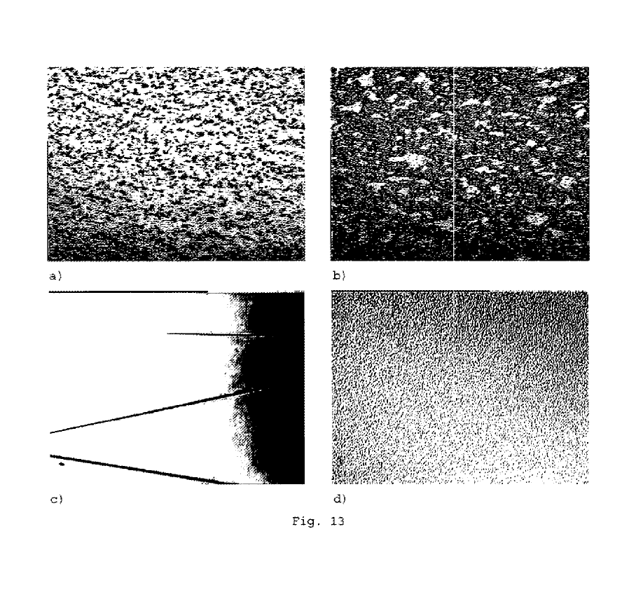

FIG. 13 shows micrographs (50×) of various coatings (a: 0.2 M; b: 0.4 M; c: 0.2 M with Daa; d: 0.4 M with Daa; 12 h at 500° C. under a nitrogen atmosphere);

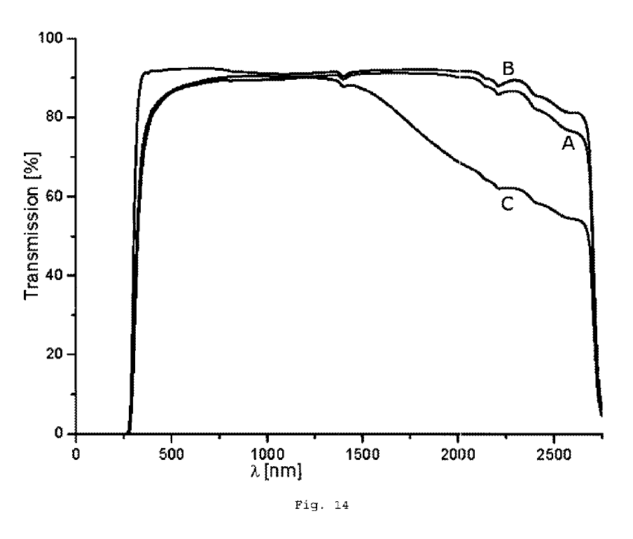

FIG. 14 shows the UV-vis-NIR spectrum of a sample of Type 11 (0.4 M) before and after reduction;

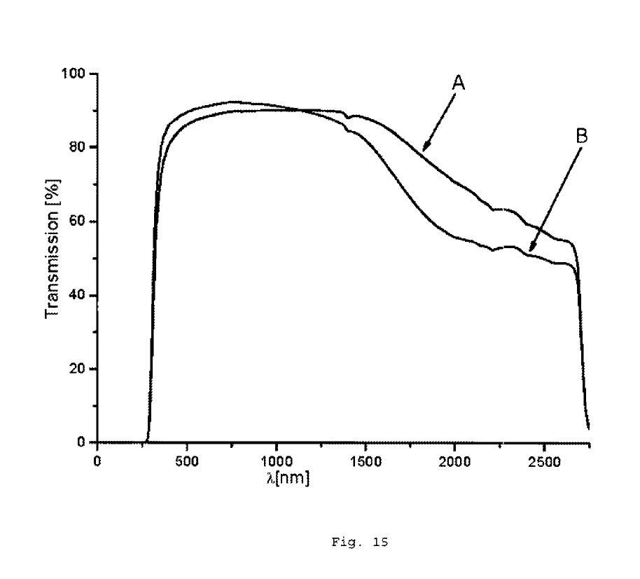

FIG. 15 shows the UV-vis-NIR spectrum of a sample of type 15 compared to a sample of type 19;

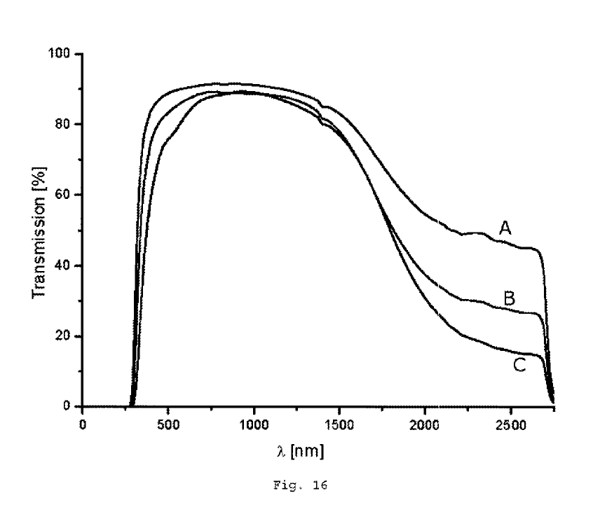

FIG. 16 shows the UV-vis-NIR spectrum of a sample having a precursor concentration of 0.4 M and a plurality of coatings;

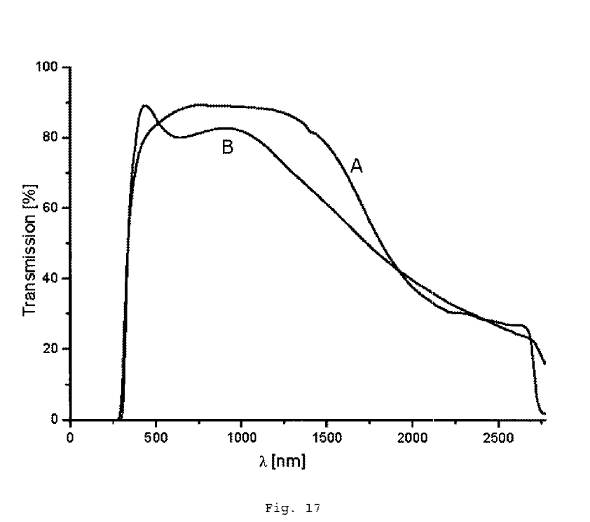

FIG. 17 shows the UV-vis-NIR spectrum of a sample compared to an industrially produced coating;

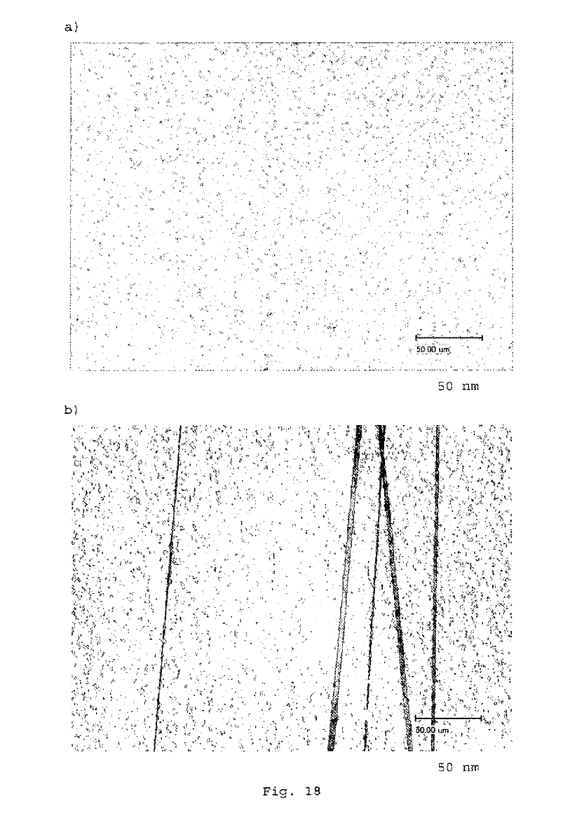

FIG. 18 shows a) a micrograph of a layer: 0.2 M and 10 at % of Sn with tert-butanol instead of Daa; 12 h at 500° C. under a nitrogen atmosphere;

b) a micrograph of a layer with scratches after double coating (coating, then heat treatment as described above and renewed coating and heat treatment: 0.4 M with Daa and 10 at % of Sn; 12 h at 500° C. under a nitrogen atmosphere);

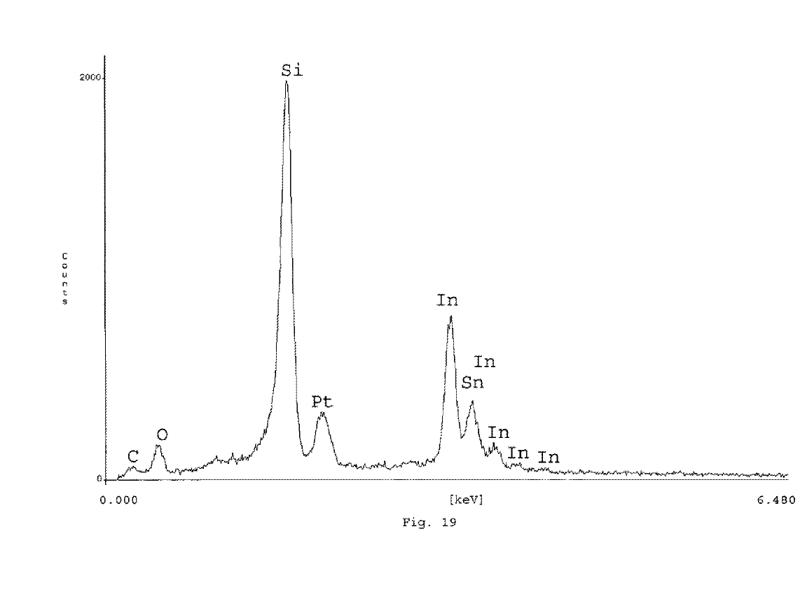

FIG. 19 shows an EDX spectrum of an ITO layer with 10 at % of Sn from a 0.4 M solution on borosilicate glass; sputtered with Pt.

In a preferred embodiment, the molar In/Sn ratio of the composition is 9/1. This gives a doping concentration of about 5-10 at % of tin (at the ratio [Sn]/([Sn]+[In])), which can ensure good electrical conductivity of ITO layers. As indium compound, preference is given to using dialkyl compounds which have an alkoxide radical as third radical. Combined with tin(II) alkoxide compounds, the following equilibrium is established:

R⁶₂InOR⁷+Sn(OR⁷)2<->R⁶₂In(OR⁷)₃Sn

Here, R⁶ is preferably a C₁-C₄-alkyl radical, particularly preferably methyl, and R⁷ is a C₂-C₆-alkyl radical, particularly preferably bulky radicals such as t-butyl or isopropyl. The equilibrium is then, for example:

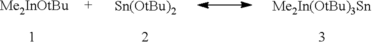

The tin compound is added in an amount depending on its tin content. As a result of the abovementioned interactions between the metal centers and the alkoxy groups, the bimetallic compound 3 is formed. This compound is extremely stable. This can be seen from the fact that an equilibrium has been established only after refluxing in toluene for a number of hours. A clear liquid which can be distilled at about 70° C. under reduced pressure is obtained as precursor composition.

If 1 and 2 are then used in the desired ratios (e.g. In/Sn=9:1), the Sn alkoxide 2 introduced is converted virtually completely into the bimetallic compound. The excess indium compound can in this way be purified by distillation together with the bimetallic compound. Any unreacted Sn compound can also be removed, for example by sublimation.

The course of the reaction could be followed by means of NMR measurements (¹H, ¹³C, ¹¹⁹Sn) in solution. If only the signals of the starting materials 1 and 2 can be seen at the beginning of the reaction, a reaction equilibrium in which the signals of the indium starting material 1 (signals at 0.07 and 1.1 ppm) and those of the product 3 (signals at 0.2 and 1.32 ppm) with only minimal traces of 2 can be seen in the NMR spectra is established after about 12 hours (FIG. 1). Table 1 shows the measured NMR signals of the bimetallic compound 3.

The product mixture of 1 and 3 obtained can be distilled under reduced pressure at moderate temperatures (about)70°). It is present in the form of wax-like components which melt at 30° C. (excess Me₂InOtBu 1) and a clear, colorless liquid (3).

The bimetallic compound is present as a stable but dynamic complex. The structure shown in FIG. 2 was able to be confirmed by NMR measurements at variable temperatures (dynamic NMR measurements) and with different ratios of the compounds.

The two terminal methyl groups (at left) lie in the same plane as the terminal tert-butyl group (at right) and perpendicular to the bridging tert-butyl groups (middle). The two parts of the In and Sn starting materials coordinate to one another and thus create the desired bonding of the Sn component to the In component by means of intramolecular interactions.

In dynamic NMR measurements at different starting material ratios (1 to 2), it was found that the product 3 formed not only undergoes the intramolecular interaction as described above but also interacts with its environment.

When 1 is used in excess, as is necessary for an ITO precursor (only about 10 at % of Sn), the Me₂InOtBu groups switch coordination sites with the Sn(OtBu)₂ component of the product. The indium group described in FIG. 1 is thus continually replaced by the surrounding indium groups. An intermolecular interaction is thus present.

The precursor composition of the invention therefore makes it possible to produce a very stable and defined mixture which allows precise setting of the doping of the future ITO layer. This is generally from 5 to 10 at % (relative to the total amount of metals) for ITO.

The concentration of tin can be measured after the synthesis process and the subsequent purification by distillation by means of atomic absorption spectroscopy (GF-AAS: graphite-furnace atomic absorption spectrometry).

The bimetallic compound can also be obtained in pure form by, for example, the reaction being carried out using an excess (e.g. 5:1) of tin compound and purifying the resulting bimetallic compound by distillation.

The NMR signals correspond to the compound which is obtained in admixture with the indium compound. NMR characterization of the bimetallic compound.

Production of the Precursor Composition:

To obtain the desired doping concentration of tin, the Sn compound has to be added in the appropriate metal ratio (In/Sn) to the indium compound, e.g. 6 at %, 8 at %, 10 at % and 50 at % of Sn. A corresponding amount of indium compound and the bimetallic compound, which are distilled together, is present in the product formed after refluxing in toluene.

Production of the Composition for Coatings

The precursor composition having the desired doping concentration of tin is dissolved in (dried) isopropanol so as to obtain a concentration of 0.6 M.

Solutions having concentrations of 0.2 M and 0.4 M are produced from this solution by addition of further isopropanol, diacetone alcohol, tert-butanol and/or acetylacetone and stored under nitrogen.

Production of the Coatings

The solution of a composition corresponding to the above method is stirred for 2 hours in the coating laboratory in order to obtain optimal homogeneity and to equilibrate the temperature of the solution with that of the surroundings. The coating solution is subsequently passed through a syringe filter (size 8) in order to filter off any solids.

Spin Coating

The composition produced is applied by spin coating. For each coating operation, 7 μl of composition are dabbed onto the middle of the stationary glass substrate and subsequently subjected to a defined coating program (speed of rotation: 1000 rpm; rotation time: 20 s). The still wet film of solution is subsequently allowed to stand for at least one minute to ensure uniform drying.

Heat Treatment in Two Steps

The coated substrates are heat treated in an air furnace at 500° C. for 12 hours (lying flat). After the samples have cooled, they are reduced in an N₂/H₂ gas atmosphere (N₂/H₂=92/8) at 300° C. in a horizontal fused silica tube furnace for 30 minutes.

Heat Treatment Under an Inert Atmosphere

The layers are, after the coating process, placed in the tube furnace and heated at 500° C. with N₂ flushing (50 l/h) for 12 hours.

The precursor system described in the section above was, in first experiments, synthesized with an In/Sn metal ratio of 9/1 and dissolved in isopropanol. This corresponds to an effective tin doping of the finished oxide of 10 at %. To improve layer formation, various proportions of diacetone alcohol were added. The addition of acetylacetone, on the other hand, proved not to be beneficial.

The results shown below all relate to the use of a precursor system with 10 at % of Sn as dopant. To vary the doping concentration, it is in this case merely necessary to vary the amount of tin starting material introduced in the precursor synthesis.

The various heat treatment processes (heat treatment+reduction and heat treatment under inert gas) were carried out to obtain data for comparing the conventional production method (with reduction) and the newly developed method (heat treatment under inert gas). Both coatings produced by spin coating and also powder samples were produced. These make more precise measurement results possible, e.g. in the case of XRD studies. Both types of sample were heat treated at 500° C. under a nitrogen atmosphere for 12 hours.

Multiple layers were produced by repeated application of the precursor solution by spin coating and subsequent heat treatment of the layers obtained.

Diffraction patterns of a layer which had been heated at 500° C. under an inert atmosphere for 12 hours are shown in FIG. 3 (10 at % of Sn from 0.4 M solution). The reference lines correspond to the signals of indium oxide (In₂O₃; ICDD: 6-416). It can be seen that all reflections of the layer material can be assigned to indium oxide and no separate phases can be discerned.

A reference sample produced by the classical production process (10 at % of Sn from 0.4 M solution; 12 hours at 500° C. in air and reduction at 300° C. under an N₂/H₂ gas mixture with 8% of H₂) gives an identical pattern (FIG. 4).

The same applies to powders produced analogously (FIG. 5).

More precise analysis of the powder diffraction pattern of a powder heat treated under an inert atmosphere shows a shift in the measured signals relative to the reference lines of In₂O₃ (FIG. 6). For this purpose, silicon powder (having signals marked as Si) was added to the powder sample in order to allow for instrument-related deviations (calibration). The measured reflections of the powder material have all been shifted to the left to smaller diffraction angles compared to the reference lines of In₂O₃ shown in blue in the diffraction pattern. According to Bragg's law, this corresponds to expansion of the oxide lattice after doping with tin and the subsequent heat treatment. This is a phenomenon known in the literature for ITO. According to Vegard's law, the substitution incorporation of small Sn⁴⁺ ions (0.69 Å) at the sites of the substantially larger In³⁺ ions (0.79 Å) must lead to a reduction in the lattice constants. However, the expansion of the lattice is due to the influence of excess tin in the oxide lattice, interstitial oxygen and the incorporation of the larger Sn²⁺ ions (0.93 Å).

The fine resolution of the X-ray diffraction patterns shows a typical behavior of the ITO samples which have been produced by the novel process. An indium oxide lattice into which the tin has been substitutionally incorporated is present. The oxide lattice expands due to excess oxygen or the incorporation of divalent Sn ions.

Solid-State NMR Measurements

To examine the disproportionation reaction of divalent tin, solid-state NMR measurements were carried out. For this purpose, two different samples were produced:

A powder sample P1 which has not been heat treated (xerogel, removal of the solvent at 50° C. in air while stirring) and powder material of P1 after 12 hours at 500° C. under nitrogen (P2). FIG. 7 shows the solid-state NMR spectrum of the sample P1 which has not been heat treated. A broad signal can be seen at about −540 ppm. Further signals cannot be discerned. The breadth of the signal is explained by the amorphous state of the sample. In the starting compound Me₂In(OtBu)₃Sn₃ the tin is present in divalent form (Sn^{II}). As a result of the elimination of the ligands by hydrolysis and the subsequent condensation step, an amorphous network of hydroxyl ions in which a considerable proportion of organic ligand radicals and solvent (isopropanol) is still present has been formed. The Sn²⁺ ion here is multiply coordinated by hydroxyl ions. The comparative value for pure tin(II) monoxide (SnO) is about −208 ppm. The shielding by these hydroxyl ions leads to a shift in the Sn²⁺ signal to the right.

Measurement of the second sample P2 (after heating under N₂) showed paramagnetic behavior of the material, which prevents formation of resonance signals. This behavior is evidence of the above-described disproportionation of the divalent tin of the starting compound and in the xerogel to the tetravalent tin ion Sn⁴⁺ and metallic Sn⁰:

2SnO<->Sn⁰+SnO₂

The Sn⁰ present is atomically distributed in the material and shows no separate phase regions in the layers or blackening of the layer.

The thicknesses of the layers produced (including multiple coatings) were determined by means of a profilometer (INM). Table 2 shows the measured layer thicknesses produced using different concentrations of the precursor solution (0.2 molar and 0.4 molar in isopropanol (HOiPr)).

The crystallite sizes of the layer material were estimated using the Scherrer method (FIG. 8, tab. 3). For this purpose, six layers were measured and their values were averaged (2 layers with 0.4 M solution with Daa, 2 layers from 0.2 M solution with Daa and 1 layer with 0.2 M solution without additive (only isopropanol) and 1 layer with 0.4 M solution without additive (only isopropanol); heat treatment: 12 h at 500° C. under N₂). No significant differences between the various samples were observed.

It can be seen that the crystallite sizes have a homogeneous distribution in the region of about 10 nm for a number of samples produced in an identical way.

This estimate agrees with the diameters of the powder particles estimated from transmission electron micrographs. Here, the powder produced under an inert atmosphere (FIG. 9) and the powder produced by the two-stage process (FIG. 10) have the same morphologies. A crystallite size of from 10 to 15 nm could also be confirmed for the powders. The powder produced under inert conditions is crystalline (diffraction pattern in FIG. 9).

The stoichiometric proportion of tin in the precursor solution (here: pure isopropanol) was determined by means of atomic absorption spectroscopy and confirms the amount of tin starting material (2) introduced.

The carbon content of the xerogel in powder form (after evaporation of the solvent at 50° C. in air) is 33% corresponding to the high residual content of organic components and a proportion of hydrogen of about 5%.

After heating under an N₂ atmosphere (500° C., 12 h), the following values of the CHN analysis are obtained (C: 0.1-0.3%; H 0%, N 0%). The measured proportions of carbon in the samples are within the measurement tolerance of the instrument (CHN-900 elemental analyzer from LECOTM) and can be influenced by adsorbed gas molecules and CO₂.

A wet-chemical determination of the metal contents (In+Sn) was carried out by means of titration (complexometric determination by means of EDTA (ethylenedinitrilotetraacetic acid disodium salt (dihydrate)) and indicate the expected total ratio of the metals in the oxide.

The absence of any further contamination by foreign atoms (halogens, nitrogen, further metals, etc.) is deserving of particular emphasis, since these have been excluded by the synthesis process for the precursor system.

Furthermore, no incorporation of nitrogen from the heat treatment atmosphere into the material can be measured.

Optical Properties

Table 4 shows the various samples produced for examination of the optical properties. Here, various samples having the same composition and produced in the same way were used for some of the various measurements (Daa: diacetone alcohol).

The multiple layers were obtained by repeated application of the composition by spin coating with subsequent heat treatment after each coating step.

In FIGS. 11 and 12, the transmission and haze of various samples is indicated. The addition of Daa leads to a significant improvement in the optical properties.

The layers produced have an obvious clarity, but this is reduced by a slight milky haze. This effect is greater, the greater the concentration of precursor material in the solution (0.2 molar and 0.4 molar solutions were usually used), the more layers have been applied and the lower the proportion of diacetone alcohol.

The transmission values of all layers produced (1×, 2×, 3×coating, using 0.2 to 0.4 molar precursor concentration and with Daa) are above 90%. This demonstrates a very homogeneous layer formation. Furthermore, it is a further indication that the metallic Sn⁰ formed is atomically distributed in the layer material and does not form any clusters which could serve as absorption and scattering sites.

FIG. 13 shows micrographs (50×enlargement) of layers with different precursor concentration and amount of additive. All samples were heat treated at 500° C. for 12 hours under nitrogen and contain a proportion of Sn of 10 at %. In the case of samples without additive, microscopic inhomogeneities can be seen (a, b). The addition of diacetone alcohol gives a significant increase in the homogeneity of the layers. The layer surface from a 0.4 molar precursor solution displays even smaller nonuniformities (d), which cannot be seen in the case of more dilute batches (0.2 molar) (c). To obtain a satisfactory contrast, mechanical scratches were introduced into the layer.

Similar micrographs of a layer produced using tert-butanol are shown in FIG. 18.

UV-vis-NIR Measurements

An important property of ITO layers is the transparency in the visible region and the reflection of infrared radiation. The measurements were all carried out against air for baseline correction. Unless indicated otherwise, the measurements are on singly coated samples.

FIG. 14 shows the curve for a layer produced by the classical route (heat treatment and reduction) using the composition of the invention.

After coating with a 0.4 molar precursor solution and crystallization in air (12 h, 500° C., A), no significant difference in the transmission curve compared to the pure substrate glass (“Borofloat blank”, B) can be seen. After reduction at 300° C. under an N₂/H₂ gas mixture (30 minutes, 8% of H₂ in N₂, C), a sharp decrease in the transmission in the near IR range is observed.

This effect at the plasma edge can be described by the Drude theory and is a sign of the formation of an electron plasma of the free conduction band electrons. The electrical and optical properties of conventional ITO layers (with reduction step) are accordingly attained only by the formation of free electrons in the reduction process.

FIG. 15 shows a comparison of the spectra of a correspondingly applied layer (0.4 molar+Daa) produced by the classical heat treatment method (sample type 15, A) and the direct nitrogen heat treatment (sample type 19, B).

It can be seen that the plasma edge of a nitrogen heat treated sample is significantly steeper and deeper than that of a conventionally treated sample after reduction for 30 minutes (which is a typical time span for this process step since otherwise there is a risk of over-reduction). Furthermore, it can be seen that the band edge (decreasing region at left) likewise appears to be steeper when the novel method is used.

The transmission in the vis range of the sample after heat treatment under N₂ is likewise apparent.

FIG. 16 shows the differences in the transmission curves after multiple coating of specimens with 0.4 M precursor concentration (Daa, 10 at % of Sn, 12 h 500° C., N₂) (A: 1 layer; B: 2 layers; C: 3 layers).

As expected, the plasma edge becomes ever steeper with increasing number of coating operations (and thus increasing layer thickness). This is due to the increased number of free charge carriers which are activated by a larger layer volume after multiple coating operations.

The transmission in the visible region is reduced in these samples and as determined by this measurement technique is merely reduced from about 92% to about 88%.

At a comparative value of 550 nm, the transmission decreases from 90% for a single layer to about 80% for a triple layer. A considerable part of this reduction in transmission is attributable to the increased haze of the layers after multiple coating operations.

FIG. 17 shows the transmission curve of a double-coated sample (2×0.4 molar, N₂ heat treatment, Daa, A) compared to an industrially manufactured ITO layer from Donnelly (since 2002: Magna Mirror Systems International Inc., B). The layer was applied to float glass (soda-lime glass) by a sputtering process and has a thickness of 105 nm.

The steeper drop in the transmission curve of the Donnelly sample indicates a higher concentration of free charge carriers in the material. The transmission in the visible range (about 400-700 nm) shows very different behavior and in the case of the layer produced by us is significantly more uniform and has a higher maximum with a substantially steeper plasma edge.

Electrical Conductivity

The electrical properties of the ITO layers were examined by the 4-point measurement method. They indicate the surface resistance of the layer in Ωsq. Multiplication by the layer thickness (in cm) gives the specific resistance of the layer in Ωcm.

Table 5 gives an overview of the values achieved up to now via this novel process for producing ITO layers:

The transmission values were determined by means of a combined transmission, haze and clarity (INM) measurement instrument.

The decrease in the surface resistances with increasing layer thickness (multiple coating) and higher precursor concentration in the coating solution can clearly be seen. The values for a double layer (3.88×10⁻³ Ωcm) are thoroughly acceptable. The transmission decreases only insignificantly.

The constancy of the transmission values of the various layers is notable. These are barely changed both at higher precursor contents in the coating operation and also in the case of multiple layers.

Experiments

The detailed data and procedures which have to be carried out in the synthesis process are described below. Here, each step of the synthesis is listed and described individually.

Owing to the high hydrolysis and oxidation sensitivity of the compounds used, all preparative work was carried out in a modified Stock vacuum apparatus under dried, after-purified nitrogen (drying columns containing magnesium perchlorate, phosphorus pentoxide and ABC catalyst).

The solvents used were dried by refluxing over soda, distilled and stored over sodium wire under a nitrogen atmosphere.

Synthesis of InCl₃

[G. Brauer: Handbuch der Präparativen and Anorganischen Chemie, Volume II, F. Enke Verlag, Stuttgart, 1978]

Granulated metallic indium (Aldrich, 99.999%) is introduced in a melting crucible into a reaction tube which is evacuated (removal of ambient air) and flushed with nitrogen gas. The tube is subsequently flooded with chlorine gas and the granulated indium is heated to 300° C. by means of a tube furnace. The chlorine gas is dried by passing it through concentrated sulfuric acid in a wash bottle before introduction into the tube. The molten/gaseous indium combines in a transport reaction with the chlorine to form indium(III) chloride (InCl₃) and, as a result of the chlorine gas stream, deposits downstream of the melting crucible as a white, crystalline powder. After the reaction is complete and the reaction tube has cooled, the remaining chlorine gas is removed by means of nitrogen. The InCl₃ formed can be collected under inert conditions (N₂) in a collection flask.

Synthesis of Me₂InCl

[H. C. Clark, A. L. Pickard, J. Organometal. Chem., 1967, 8, 427-434]

Twice the stoichiometric amount of methyllithium (1.6 M in diethyl ether, Aldrich) is slowly added dropwise to a suspension of indium(III) chloride (InCl₃) in diethyl ether while stirring continually and the reaction solution is stirred at room temperature for 2 days. After the LiCl precipitate has been filtered off and the solvent has been removed under reduced pressure, the product which remains is sublimed at 110° C. under reduced pressure.

Synthesis of Li(OtBu)

[H. Nekola, F. Olbrich, U. Behrens, Z. Anorg. Allg. Chem. 2002, 628, 2067-2070]

tert-Butyllithium (2.5 M in hexane, equimolar, Aldrich) is slowly added dropwise to a solution of tert-butanol in hexane and the butane formed is allowed to escape. After one hour of boiling under reflux, the solvent is evaporated and the white solid which remains is sublimed at 120° C. under reduced pressure.

Synthesis of Me₂In(OtBu)

[e.g. O. T. Beachley Jr., D. J. MacRae, M. R. Churchill, A. Y. Kovalevski, E. S. Robirds, Organometallics, 2003, 22, 3991-4000]

An equimolar LiOtBu solution in diethyl ether is added dropwise to a solution of Me₂InCl in diethyl ether while stirring continually and the reaction mixture is stirred for 12 hours. After the LiCl precipitate has been filtered off, the solvent is removed under reduced pressure and the wax-like solid which remains is transferred directly by sublimation at 35° C. into a collection flask (“flask-to-flask sublimation”).

Synthesis of LiN(SiMe₃)₂

[U. Wannagat, H. Niederprüm, Chem. Ber. 1961, 94, 1540]

A solution of tert-butyllithium (1.6 M in hexane, Aldrich) is added dropwise to an equimolar amount of 1,1,1,3,3,3-hexamethyldisilazane (Aldrich) and the butane formed is allowed to escape. After boiling under reflux for 2 hours, the reaction solution is stored at −30° C. for 24 hours. After formation of crystals, the excess solvent is removed and the crystals are dried under reduced pressure.

Synthesis of Sn(N(SiMe₃)₂)₂

[M. Veith, Angew Chem 1975, 87, 287-288]

Tin(II) chloride (SnCl₂, Aldrich) is added in half the stoichiometric ratio to a solution of LiN(SiMe₃)₂ in diethyl ether, resulting in the solution becoming red. After stirring for 4 hours, the LiCl precipitate is filtered off and the solvent is taken off. The product which remains is subsequently distilled at 130° C. under reduced pressure.

Synthesis of Sn(OtBu)₂

[M. Veith, F. Töllner, J. Organomet. Chem. 1983, 246, 219]

Twice the stoichiometric amount of tert-butanol is added dropwise at room temperature to a solution of Sn(N(SiMe₃)₂)₂ in toluene, as a result of which the formerly red solution becomes decolorized. After stirring for 2 hours, the remaining solvent is removed together with the remaining hexamethyldisilazane under reduced pressure and the white residue which remains is sublimed at 60° C.

Synthesis of Me₂In(OtBu)₃Sn

A solution of Sn(OtBu)₂ in toluene is added dropwise to a solution of Me₂InOtBu in toluene and the reaction solution is boiled under reflux for 12 hours. After removal of the solvent under reduced pressure, the product which remains is distilled at 70° C. under reduced pressure.

Production of a Precursor Composition Containing 10 at % of Sn

6.39 g of Me₂InOtBu are dissolved in 80 ml of toluene. In a second flask, 0.86 g of Sn(OtBu)₂ is dissolved in 30 ml of toluene and this solution is added dropwise to the Me₂InOtBu solution while stirring continually. The reaction mixture is stirred under reflux at 110° C. for 12 hours. The solvent is subsequently removed under reduced pressure (10⁻³ mbar). The product which remains is then distilled at 70° C. under reduced pressure. The collection flask is cooled externally by means of acetone/dry ice. This gives 6.595 g of precursor (mass yield: 91%).

Production of a Precursor Composition Containing 6 at % of Sn

2.624 g of Me₂InOtBu are dissolved in 50 ml of toluene. In a second flask, 0.204 g of Sn(OtBu)₂ is dissolved in 25 ml of toluene and this solution is added dropwise to the Me₂InOtBu solution while stirring continually. The reaction mixture is stirred under reflux at 110° C. for 12 hours. The solvent is subsequently removed under reduced pressure (10⁻³ mbar). The product which remains is then distilled at 70° C. under reduced pressure. The collection flask is cooled externally by means of acetone/dry ice. This gives 2.554 g of precursor (mass yield: 90.3%).

Production of a Composition for Coatings (0.4 M Precursor Composition; 10 at % of Sn With Diacetone Alcohol)

6.595 g of precursor (10 at % of Sn) are dissolved in 50 ml of isopropanol and stirred in order to obtain a 0.5923 molar stock solution. 2 ml of the solution are subsequently taken and 0.96 ml of diacetone alcohol (Daa) is added thereto to give a 0.4 M precursor solution.

Preparation of Substrates

Glass substrates of borosilicate glass (Schott, Borofloat33, thickness: 3 mm, 60×60 mm²) which had been cut to size were polished by means of a slurry of cerium oxide powder and subsequently cleaned in a laboratory dishwasher, with multiple rinsing with deionized water being carried out as last rinsing operation.

Coating of a Borofloat Substrate With Composition (0.4 M Precursor Composition; 10 at % of Sn; Daa)

The coating solution is stirred at room temperature for 2 hours and filtered through a syringe filter. The glass substrate is fixed to the chuck of the spin coater by means of reduced pressure. By means of a pipette, 0.7 μl of the coating solution is taken and placed in the middle of the substrate. The substrate is subsequently allowed to rotate at 1000 rpm for 20 seconds, as a result of which the coating solution becomes uniformly distributed over the substrate. After the rotation operation is complete, the reduced pressure fixing of the substrate is released and the wet layer is allowed to stand until the film of solution has been partially dried. The sample can then be heat treated in the horizontal position in a furnace.

Heat Treatment in Two Steps

The coated substrates are heat treated (lying flat) at 500° C. in an air furnace for 12 hours. After the samples have cooled, they are reduced for 30 minutes at 300° C. in an N₂/H₂ gas atmosphere (N₂/H₂=92/8) in a horizontal fused silica tube furnace.

Heat Treatment Under an Inert Atmosphere

The layers are, after the coating process, placed in the tube furnace and heat treated at 500° C. with N₂ flushing (50 l/h) for 12 hours.

Production of a Powder Sample From a 0.4 M Coating Solution (10 at % of Sn+Daa)

30 ml of a 0.4 M precursor composition are taken and placed in a glass beaker. While stirring continually, the solvent is removed at 50° C. in air. The powder formed is subsequently ground by means of a hard mortar and introduced in a powder crucible into the furnace and treated by means of one of the above-described heat treatments.

### LIST OF REFERENCES CITED

G. Brauer: Handbuch der Präparativen und Anorganischen Chemie, Volume II, F. Enke Verlag, Stuttgart, 1978

H. C. Clark, A. L. Pickard, J. Organometal. Chem., 1967, 8, 427-434

H. Nekola, F. Olbrich, U. Behrens, Z. Anorg. Allg. Chem. 2002, 628, 2067-2070

O. T. Beachley Jr., D. J. MacRae, M. R. Churchill, A. Y. Kovalevski, E. S. Robirds, Organometallics, 2003, 22, 3991-4000

U. Wannagat, H. Niederprüm, Chem. Ber. 1961, 94, 1540

M. Veith, Angew Chem 1975, 87, 287-288

M. Veith, F. Tollner, J. Organomet. Chem. 1983, 246, 219

TABLE 1

| ¹H [ppm] | ¹³C [ppm] | ¹¹⁹Sn [ppm] |
|---|---|---|
| 1.33 | 71.73 | −168.25 (C₆D₆) |
| 0.08 | 33.57 | |
| | 0.40 | |

TABLE 2

| Precursor conc. | Layer thickness [nm] |
|---|---|
| 0.2M | 33-36 |
| 0.4M | 150-160 |

Double layers

| | |
|---|---|
| 0.2M | 160-170 |
| 0.4M | 220-260 |

TABLE 3

| Precursor | | Heat | | Phase | Crystallite |
|---|---|---|---|---|---|
| concentration | Additive | treatment | Layers | Name | size [nm] |
| 0.4M | Daa | 1-stage | 1 | Bixbyite | 10 |
| 0.4M | — | 1-stage | 1 | Bixbyite | 9 |
| 0.2M | Daa | 1-stage | 1 | Bixbyite | 11 |
| 0.2M | Daa | 1-stage | 1 | Bixbyite | 11 |
| 0.4M | Daa | 1-stage | 1 | Bixbyite | 10 |
| 0.2M | — | 1-stage | 1 | Bixbyite | 10 |

TABLE 4

| | [Precursor | | | Heat |
|---|---|---|---|---|
| Sample | composition] | Additive | Layers | treatment |
| 10 | 0.2M | — | 1 | 2-stage |
| 11 | 0.4M | — | 1 | 2-stage |
| 12 | 0.2M | — | 2 | 2-stage |
| 13 | 0.4M | — | 2 | 2-stage |
| 14 | 0.2M | Daa | 1 | 2-stage |
| 15 | 0.4M | Daa | 1 | 2-stage |
| 16 | 0.2M | Daa | 2 | 2-stage |
| 17 | 0.4M | Daa | 2 | 2-stage |
| 18 | 0.2M | Daa | 1 | Inert |
| 19 | 0.4M | Daa | 1 | Inert |

TABLE 5

| | Layer | | | Trans- |
|---|---|---|---|---|
| | Thickness | Surface | | mission |
| Coating | [nm] | resistance | Spec. resistance | (vis) |
| 0.2M + Daa | 33 nm | 2800 Ω sq | 9.24 × 10 − 3 Ω cm | 94% |
| after N₂ | | | | (+/−0.0) |
| heat | | | | |
| treatment | | | | |
| 0.4M + Daa | 146 nm | 317 Ω sq | 4.63 × 10 − 3 Ω cm | 93.7% |
| after N₂ | | | | (+/−0.0) |
| heat | | | | |
| treatment | | | | |
| Double | 224 nm | 173.3 Ω sq | 3.88 × 10 − 3 Ω cm | 92.2 |
| coating | | | | (+/−0.06) |
| (0.4M) N₂ | | | | |
| heat | | | | |
| treatment | | | | |

1. A composition for producing ITO powders or ITO coatings, comprising:
a) at least one indium compound; and
b) at least one bimetallic compound comprising indium and tin.

2. The composition as claimed in claim 1, wherein the tin is present in the oxidation state +2 in the bimetallic compound.

3. The composition as claimed in claim 1, wherein the bimetallic compound comprises a coordination compound of a tin compound with an indium compound.

4. The composition as claimed in claim 1, wherein the indium compound comprises a dialkylindium compound.

5. The composition as claimed in claim 1, wherein the indium compound comprises a compound of the general formula (II)
R⁴₂InOR⁵ (II)
and the bimetallic compound comprises a compound of the general formula (III)
R⁴₂In(OR⁵)₃Sn (III)
where R⁴ and R⁵ are identical or different and are each a linear or branched alkyl radical having from 1 to 8 carbon atoms.

6. The composition as claimed in claim 1, wherein the composition has a proportion of from 1 to 50 at % of tin ([Sn]/([Sn]+[In])).

7. The composition as claimed in claim 1, wherein the composition further comprises one or more organic compounds having Lewis-basic groups.

8. The composition as claimed in claim 7, wherein the organic compounds are selected from the group consisting of C₁₋₆-alcohols, carbonyl compounds, β-hydroxyketones, β-diketones, and (poly)ethers.

9. A bimetallic precursor, comprising a coordination compound of an indium compound and a tin compound and comprises tin in the oxidation state +2.

10. A process for producing ITO coatings, comprising the following steps:
a) production of a composition composed of at least one indium compound and at least one bimetallic compound comprising indium and tin;
b) application of the composition to a substrate; and
c) heat treatment at above 300° C.

11. The process as claimed in claim 10, wherein the heat treatment is carried out under an inert atmosphere.

12. The process as claimed in claim 10, wherein the heat treatment is carried out in two stages, with the second step being carried out in a reducing atmosphere.

13. The process as claimed in claim 10, wherein the composition further comprises one or more organic compounds having Lewis-basic groups.

14. The process as claimed in claim 13, wherein the organic compounds are selected from the group consisting of C₁₋₆-alcohols, carbonyl compounds, β-hydroxyketones, β-diketones, and (poly)ethers.

15. The process for producing an ITO powder as claimed in claim 10, wherein, instead of step b), the composition is dried at below 100° C. and then subjected to a comminution treatment.

16. An article comprising containing a coating as claimed in claim 10.
